(19) United States
(12) Patent Application Publication
(10) Pub. No.: US 2008/0083011 A1
(43) Pub. Date: Apr. 3, 2008

(54) Protocol/API between a key server (KAP) and an enforcement point (PEP)

(76) Inventors: Donald McAlister, Apex, NC (US); John Cary Orange, Raleigh, NC (US)

Correspondence Address: HAMILTON, BROOK, SMITH & REYNOLDS, P.C., 530 VIRGINIA ROAD, P.O. BOX 9133, CONCORD, MA, 01742-9133, US

(21) Appl. No.: 11/541,424

(22) Filed: Sep. 29, 2006

(51) Int. Cl. H04L 9/00

(52) U.S. Cl. 726/1

(57) ABSTRACT

An Application Programming Interface (API) for communicating security policy information between a Key Authority Point (KAP) and a Policy Enforcement Point (PEP), thereby eliminating the need to manually install security policies on each network device.

### BACKGROUND OF THE INVENTION

The present invention relates to securing message traffic in a data network, and more particularly to communicating security policy information between Key Authority Points (KAPs) and Policy Enforcement Points (PEPs).

The following definitions are used in this document:

“Securing” implies both encryption of data in transit as well as authenticating that the data has not been manipulated in transit.

A “security policy” (or “policy”) defines data (or “traffic”) to be secured by a source IP address, a destination IP address, a port number, and/or a protocol on a network layer (layer-3), or over a data link (layer-2). The security policy also defines a type of security to be performed.

A “key” is a secret information used to encrypt or to decrypt (or to authenticate and to verify) data in one direction of traffic.

A “security group” (SG) is a collection of member end-nodes or subnets that are permitted to access or otherwise communicate with each other. A security policy may be configured with a security group and end nodes associated with that group.

A “Management and Policy Server” (MAP) is a device that is used to define high level security policies, which it then distributes to one or more Key Authority Points (KAPs).

A “Key Authority Point” (KAP) is a device that generates detailed policies from high level policies, which it then distributes to Policy Enforcement Points (PEPs).

A “Policy Enforcement Point” (PEP) is a device that secures traffic based on a policy.

A “transaction” is a communication of policy and/or key information between a KAP and a PEP.

### Existing Network Security Technology

Computer network traffic is normally sent unsecured without encryption or strong authentication by a sender and a receiver. This allows the traffic to be intercepted, inspected, modified, or redirected. Either the sender or the receiver can falsify their identity. In order to allow private traffic to be sent in a secure manner, a number of security schemes have been proposed and are in use. Some are application dependent, as with a specific program performing password authentication. Others, such as Transport Layer Security (TLS), are designed to provide comprehensive security to whole classes of traffic, such as Hypertext Transfer Protocol (HTTP) (i.e., web pages), File Transfer Protocol (FTP) (i.e., files), Ethernet, and Point-to-Point Protocol (PPP).

Internet Security (IPsec) was developed to address a broader security need. As the majority of network traffic today is over Internet Protocol (IP), IPsec was designed to provide encryption and authentication services to IP traffic regardless of the application or transport protocol. This is done in IPsec tunnel mode by encrypting a data packet (if encryption is required), performing a secure hash (authentication) on the packet, then wrapping the resulting packet in a new IP packet indicating it has been secured using IPsec.

The secrets and other configurations required for this secure tunnel must be exchanged by the involved parties to allow IPsec to work. This is done using Internet Key Exchange (IKE). IKE key exchange is done in two phases.

In a first phase (IKE Phase 1), a connection between two parties is started in the clear. Using public key cryptographic mechanisms, where two parties can agree on a secret key by exchanging public data without a third party being able to determine the key, each party can determine a secret for use in the negotiation. Public key cryptography requires each party either share secret information (pre-shared key) or exchange public keys for which they retain a private, matching, key. This is normally done with certificates, e.g., Public Key Infrastructure (PKI). Either of these methods authenticates the identity of the peer to some degree.

Once a secret has been agreed upon in IKE Phase 1, a second phase (IKE Phase 2) can begin where the specific secret and cryptographic parameters of a specific tunnel are developed. All traffic in IKE Phase 2 negotiations is encrypted by the secret from IKE Phase 1. When these negotiations are complete, a set of secrets and parameters for security have been agreed upon by the two parties and IPsec secured traffic can commence.

When a packet is detected at a Security Gateway (SGW) with a source/destination pair that requires IPsec protection, the secret and other Security Association (SA) information are determined based on the Security Policy Database (SPD), and IPsec encryption and authentication is performed. The packet is then directed to a SGW that performs decryption. At the receiving SGW, the IPsec packet is detected, and its security parameters are determined by a Security Parameter Index (SPI) in the outer header. This is associated with the SA and the secrets are found for decryption and authentication. If the resulting packet matches the policy, it is forwarded to the original recipient.

### Limitations of Existing Network Security Technology

Although IPsec tunnel mode has been used effectively in securing direct data links and small collections of gateways into networks, a number of practical limitations have acted as a barrier to a more complete acceptance of IPsec as a primary security solution throughout the industry.

One such problem results from the need to manually configure policies. Members in a secure network, either individuals or subnets, often want secure communication to a few other individuals, either locally or remotely. These network security functions typically allow for defining policies that specify security groups (SGs). Each SG includes member individuals or subnets that are permitted access to each other, however, configuration of the policies to enforce this is challenging and requires a local administrator to have detailed knowledge of remote networks or for a global security administrator to have authorization to configure all units.

### SUMMARY OF THE INVENTION

In a preferred embodiment, the invention is a method or an apparatus for communicating security policy information between at least one Key Authority Point (KAP) and at least one Policy Enforcement Point (PEP), thereby eliminating the need to manually install security policies on each network device. The policies are, instead, defined in a high level manner. The at least one KAP then generates detailed policy information based on the high level definitions, and distributes the detailed policy information (in a format that conforms to an Application Programming Interface (API)) to the at least one PEP over a network. The detailed policy information is received and stored at the at least one PEP.

In one embodiment, the policy communicating method communicates a policy name, server information, transaction information, and transaction details. The server information may specify one of the at least one KAPs from which the policy is being communicated. The transaction information may specify a deferred reload time, a transaction type, or both. The transaction type may correspond with the type of information that is contained in the transaction details, such as a “replace” transaction. The transaction details may include details for a particular type of transaction, such as a “replace” transaction. Included in the transaction details may be a set of security policy rules, which may contain zero or more policy rules. A policy action may be specified within a policy rule.

In another embodiment, the policy communicating method includes the communicating of at least one key.

In yet another embodiment, the policy communicating method uses TLS to communicate the detailed policy information.

In yet another embodiment, the policy communicating method uses Remote Procedure Calls encoded with an Extensible Markup Language (XML-RPC) protocol to communicate the detailed policy information.

### BRIEF DESCRIPTION OF THE DRAWINGS

The foregoing will be apparent from the following more particular description of example embodiments of the invention, as illustrated in the accompanying drawings in which like reference characters refer to the same parts throughout the different views. The drawings are not necessarily to scale, emphasis instead being placed upon illustrating embodiments of the present invention.

FIG. 1 is a network diagram of an example wide area data communications network implementing an embodiment of the present invention;

FIG. 2 is a block diagram that illustrates the hierarchical relationship between policy management, policy/key generation and distribution, and policy enforcement in accordance with an embodiment of the present invention;

FIG. 3 is a block diagram of an example API for a transaction in accordance with an embodiment of the present invention;

FIG. 4 is a block diagram of an example policy rule as part of a transaction details component of an API for a “replace” transaction in accordance with an embodiment of the present invention;

### DETAILED DESCRIPTION OF THE INVENTION

A description of example embodiments of the invention follows.

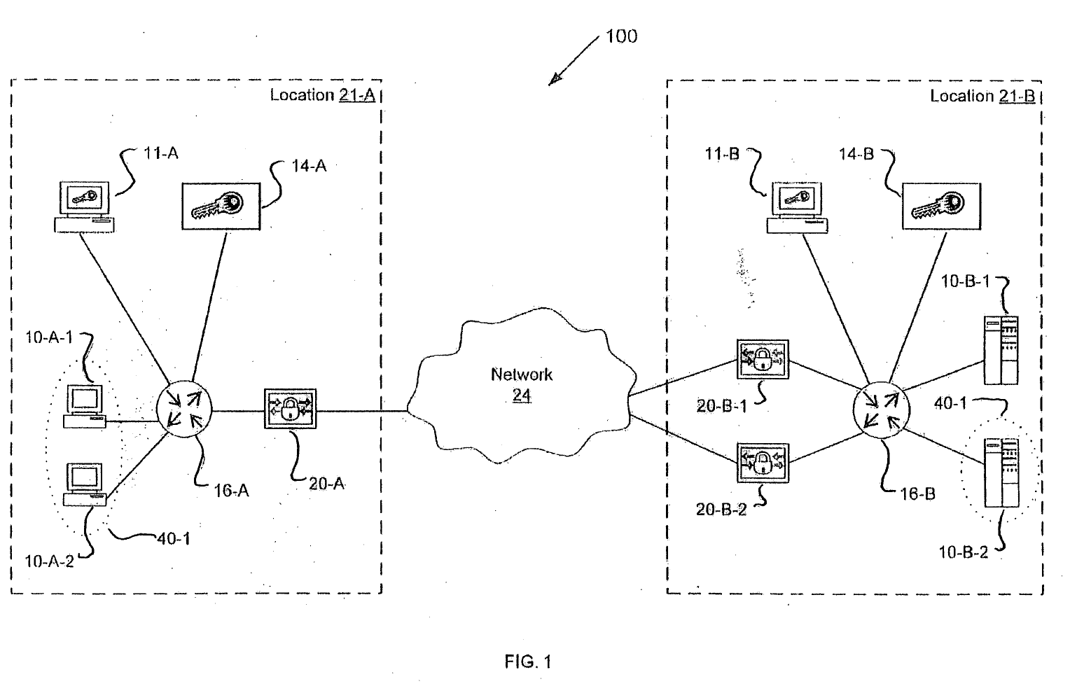

FIG. 1 illustrates an example wide area data communications network 100 implementing an embodiment of the present invention. In the network 100, a location 21-a generally has a number of data processors and functions including end nodes 10-a-1 and 10-a-2, a Management and Policy Server (MAP) function 11-a, a Key Authority Point (KAP) function 14-a, an inter-networking device 16-a, such as a router or a switch, and a Policy Enforcement Point (PEP) function 20-a. Typically, the network 100 includes at least one other location, such as location 21-b that implements end nodes 10-b-1 and 10-b-2, a MAP function 11-b, a KAP function 14-b, and PEP functions 20-b-1 and 20-b-2.

Locations 21-a and 21-b may be subnets, physical Local Area Network (LAN) segments, or other network architectures. The locations 21-a and 21-b may typically be logically separate from each other and from other locations 21. A location 21 may be a single office that may have only a few computers, or may be a large building, complex, or campus that has many different data processing machines installed therein. For example, location 21-a may be a west coast headquarters office located in Los Angeles and location 21-b may be an east coast sales office located in New York.

The end nodes 10-a-1, 10-a-2, 10-b-1, and 10-b-2 (collectively, end nodes 10) in a location 21 may be typical client computers, such as Personal Computers (PCs), workstations, Personal Digital Assistants (PDAs), digital mobile telephones, wireless network-enabled devices, and the like. Additionally, the end nodes 10 may be file servers, video set top boxes, data processing machines, or other devices capable of being networked from which messages are originated and to which messages are destined.

Messages (or traffic) sent to and from the end nodes 10 typically take the form of data packets in an Internet Protocol (IP) packet format or layer-2 formats. As is well known in the art, an IP packet may encapsulate other networking protocols such as Transmission Control Protocol (TCP), User Datagram Protocol (UDP), or other lower level and higher level networking protocols.

In the example wide area data communications network 100, the Policy Enforcement Points (PEPs) 20 cooperate with the Management and Policy Servers (MAPs) 11, and the Key Authority Points (KAPs) 14 to secure message traffic between the end nodes 10 according to security policies. Recall that a security policy (or “policy”) defines data (or “traffic”) to be secured by a source IP address, a destination IP address, a port number, and/or a protocol on a network layer (layer-3), or over a data link (layer-2). The security policy also defines a type of security to be performed on the traffic.

At each location 21 there is a Management and Policy Server (MAP) 11 (e.g., the MAP 11-a at the location 21-a). Each MAP 11 is a data processing device, typically a PC or a workstation, through which an administrative user inputs and configures high level security policies. The MAP 11 also acts as a secure server that stores and provides access to security policies by other elements or functions of the example wide area data communications network 100. The KAPs 14, and PEPs 20 cooperate to secure message traffic between the end nodes 10 according to security policies. Each KAP function 14 is responsible for generating and distributing “secret data” known as encryption keys to their respective PEP functions 20. For example, the KAP function 14-a generates and distributes keys to the PEP function 20-a. In general, traffic between the modules described above is either local (within a single device) or protected by a secure tunnel in a wide area network 24 that provides the wide area connections between locations 21.

The example network 100 includes at least one Security Group (SG) 40. Recall that a SG is a collection of member end-nodes or subnets that are permitted to access or otherwise communicate with each other. Also recall that a security policy may be configured with a SG and end nodes associated with that SG. Information regarding a SG may be maintained in the MAP 11 at each location 21 (e.g., MAP 11-a at location 21-a, and MAP 11-b at location 21-b) or distributed by a centralized authentication server (not shown).

In the example wide area data communications network 100, end nodes 10-a-1 and 10-a-2 in location 21-a are part of a Security Group (SG) 40-1. The SG 40-1 also includes end node 10-b-2 in location 21-b. A security policy (not shown) is created at location 21-a to associate end nodes 10-a-1 and 10-a-2 with the SG 40-1. Information concerning membership of end node 10-b-2 at location 21-b need not be provided to the MAP 11-a at location 21-a. Instead, another security policy (not shown) is created at location 21-b associating end node 10-b-2 with the SG 40-1. Likewise, the security policy at location 21-b need not specify end nodes 10-a-1 and 10-a-2 of location 21-a.

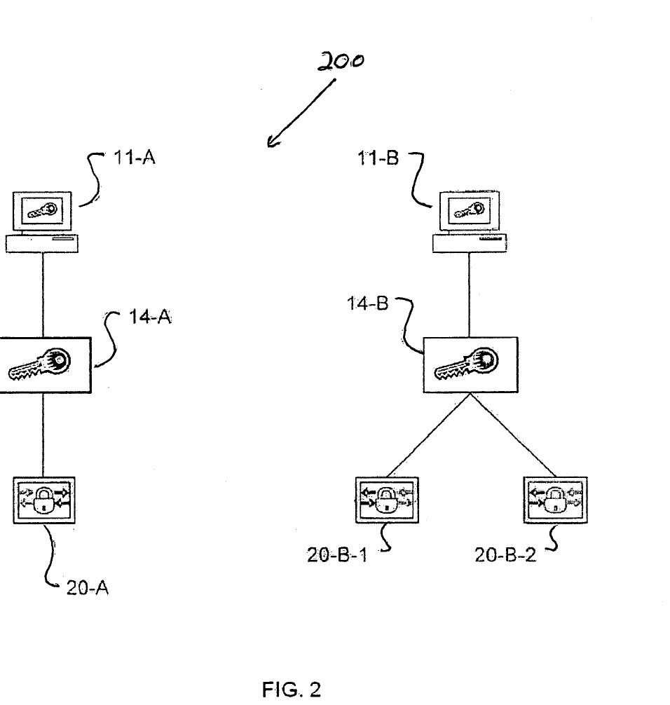

FIG. 2 is a block diagram that illustrates the hierarchical relationship 200 between policy management, policy/key generation and distribution, and policy enforcement in accordance with an embodiment of the present invention.

MAPs 11 communicate high level security policy definitions to one or more KAPs 14. In the embodiment shown, each KAP 14 receives the high level policy definitions from only one MAP 11 (MAP 11-a for KAP 14-a, and MAP 11-b for KAP 14-b). Each KAP 14 uses the policy definitions to determine the PEPs 20 to which it is responsible, and which networks the PEPs 20 protect. Based on the high level policies defined by the MAP 11, each KAP 14 generates detailed policy information for only those PEPs 20 that are in the KAP's 14 control, and distributes the detailed policy information to the appropriate PEPs 20.

In the case of FIG. 2, MAP 11-a communicates high level security policies to KAP 14-a. KAP 14-a then generates detailed policy information for PEP 20-a because, as defined by the security policies from MAP 11-a, PEP 20-a is controlled by KAP 14-a. Likewise, MAP 11-b communicates high level security policies to KAP 14-b. KAP 14-bthen generates detailed policy information for PEP 20-b-1 and PEP 20-b-2, as they are controlled by KAP 14-b.

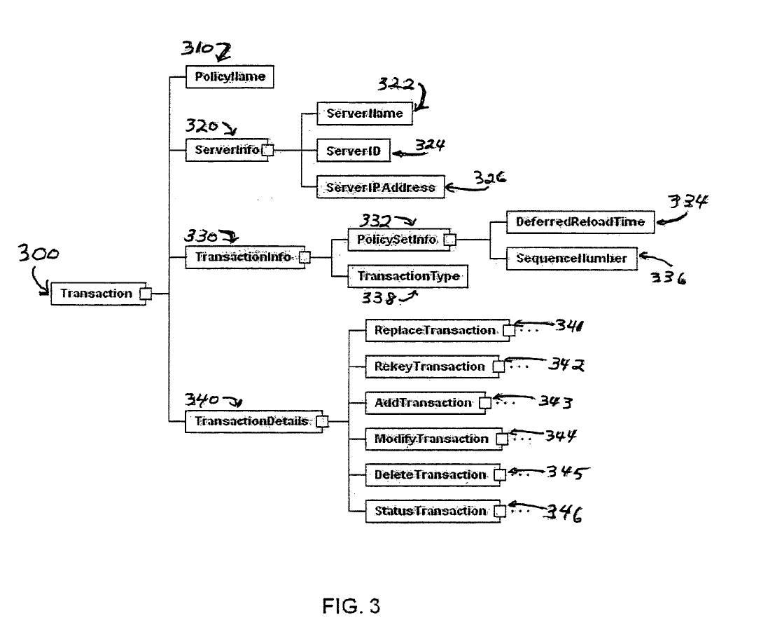

FIG. 3 is a block diagram of an example API for a transaction 300 in accordance with an embodiment of the present invention.

The API defines the format of security policy transactions and security policy rules for processing on a PEP 20. A KAP 14 generates and communicates the transactions to a PEP 20. Supported transactions include: “replace”, “rekey”, “add”, “modify”, “delete”and “status”. The transactions are received at the PEP 20 via Remote Procedure Calls encoded with an Extensible Markup Language (XML-RPC) on a port protected by TLS, and are only processed by the PEP 20 when it is operating in “distributed key mode”.

Each transaction 300 specifies a policy name 310, which is the name of the meta-policy covering all policies to be stored on the PEP 20. Each transaction 300 also specifies a server information component 320 that contains information about the KAP 14 that originated the transaction 300. The PEP 20 uses the server information 320 to group transactions and policies from a particular KAP 14, enabling the PEP 20 to distinguish between policies from different KAPs 14, and to store each KAP's 14 policies separately such that they will not overwrite each other. It should be noted that separate KAPs 14 may control one PEP 20. The server information component 320 includes the key server name 322, its unique numeric identifier 324, and its IP address 326.

Each transaction 300 also includes a transaction information component 330, which includes a transaction type 338, and a policy set information component 332. The transaction type 338 specifies the type of transaction being communicated by the KAP 14 (replace, rekey, add, modify, delete, or status). The policy set information component further includes a sequence number 336 and a deferred reload time 334.

The PEP 20 stores and uses the transaction sequence number 336 to keep track of the latest policy updates from the KAP 14. The KAP 14 uses the sequence number 336 to track transactions on subsequent status queries. Typically, the transaction sequence number 336 starts at zero and increments by one for each transaction communicated by the KAP 14 to the PEP 20.

The deferred reload time 334 is an optional value that is used when delaying the processing time of the transaction on the PEP 20. The deferred reload time 334 instructs the PEP 20 when to enact the policy, allowing for coordinated policy insertion with other PEPs 20 in a network. When a deferred reload time 334 is specified, the PEP 20 caches the transaction 300 and schedules an event to process the transaction 300 at the specified date and time. The purpose of the deferred reload time 334 is to allow synchronization of the policy reloads on all PEPs 20 in the network with minimal traffic disruption.

Each transaction 300 also includes a transaction details component 340 that contains the information for a particular type of transaction. A “replace” transaction 341 includes a complete list of policy rules communicated by a KAP 14 for installation on the PEP 20. A “rekey” transaction 342 includes information for updating the keys for current policies on the PEP 20. An “add” transaction 343 includes information for adding one or more policies to the PEP 20. A “modify” transaction 344 includes information for modifying policies stored on the PEP 20. A “delete” transaction 345 includes information for deleting one or more specified policies from the PEP 20. A “status” transaction 346 includes information needed for retrieving the PEP's 20 status.

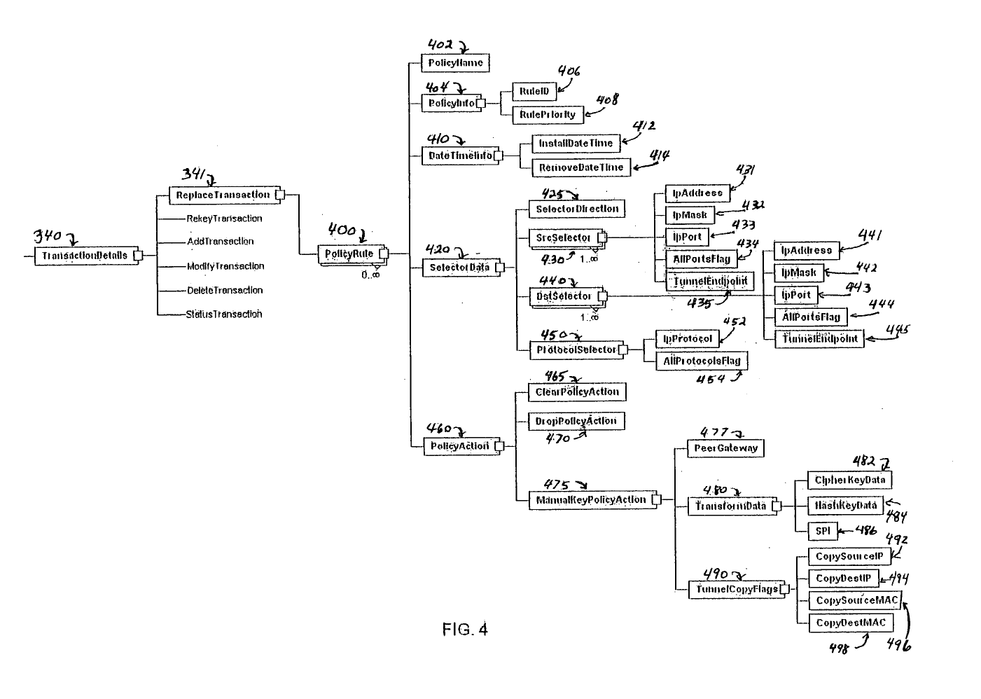

FIG. 4 is a block diagram of an example policy rule 400 as part of a transaction details component 340 of an API for a “replace” transaction 341 in accordance with an embodiment of the present invention.

A “replace” transaction 341 includes a complete list of policy rules 400 sent by a KAP 14 for installation on a PEP 20. Upon processing a “replace” transaction, the PEP 20 removes any policy rules 400 that if had previously received from the KAP 14 and stores the new set of rules on a file system. The PEP 20 includes a Security Policy Database (SPD), a Content Addressable Memory (CAM), and a Security Association Database (SADB). The SPD and SADB store security policies. The CAM is used in high speed packet processing and stores addresses of devices that are assigned to security groups. The PEP 20 then reprioritizes all of its stored security polices for all KAPs 14, resets and reinitializes the SPD, CAM, and SADB, and reloads all the new polices. The PEP 20 expects all of the policy rules 400 to be complete, with the exception that a manual key policy 475 may be specified without a transform data component 480. In this case, the PEP 20 will not activate the policy until it receives the transform data component 480 in a subsequent “rekey” transaction 342.

Security policies on the PEP 20 are defined by a policy rule structure 400. A complete policy rule 400 defines all of the information necessary for installing the policy information into the SPD and CAM on the PEP 20, and activating the policy for processing. An incomplete policy rule 400 defines all of the selector information 420 such that the PEP 20 may install the policy into its SPD and CAM in a deactivated state until the remaining information is provided in a subsequent transaction.

Each policy rule 400 is atomic in nature, that is, it has no relationship with or dependency on any other policy rule on the PEP 20. PEPs 20 do not have any knowledge of the overall context of its policies within a network. It is the KAPs 14 that track the policy rules at the higher level.

Each policy rule 400 includes a name 402, which is the name of the policy, and a policy information component 404. The policy information component 404 includes a rule identifier 406, which is unique to the originating KAP 14, and a priority value 408. The server information 320 together with the policy information 404 provide the necessary information to uniquely identify the security policy on the PEP 20. The rule identifier 406 is used by a KAP 14 during subsequent transactions to modify or query the status of the policy rule 400. The priority value 408 is used by the PEP 20 to order policies within the SPD and CAM.

Each policy rule 400 includes a date and time information component 410, which further includes an install value 412, and a remove value 414. These values 412, 414 represent the lifetime of the policy rule 400. The PEP 20 uses the install and remove values 412, 414 to activate and deactivate the policy rule 400 for traffic, respectively. The install values 412, 414 specify the absolute date and time that the policy rule 400 should be activated or deactivated.

Each policy rule 400 includes a selector data component 420 that defines where the policy rule 400 should be installed on the PEP 20. The selector data component 420 includes a selector direction 425, source and destination selectors 430, 440, and a protocol selector 450. The selector direction 425 specifies whether the policy rule 400 is an “inbound” or “outbound” policy with respect to the PEP's 20 remote port interface. The protocol selector 450 includes the protocol number 452 and the “all protocols” flag 454. The source and destination selectors 430, 440 each specify a source/host network, and for layer-3, are complete with IP addresses 431, 441, subnet masks 432, 442, port numbers 433, 443, and “all port numbers” flags 434, 444. Optional tunnel end points 435, 445 may be included with each of the source and destination selectors 430, 440. A tunnel end point specifies the IP address and subnet mask to be used for outer Encapsulating Security Payload (ESP) headers on IPsec policies. Each policy rule 400 must include at least one source selector 430 and at least one destination selector 440 to be complete. It should be noted that multiple source and destination selectors in a single policy rule 400 will result in multiple SPD, CAM, and SADB entries on the PEP 20.

Each policy rule 400 includes a policy action 460 (clear, drop, or manual key). Clear and drop policy actions 465, 470 are stored in the SPD and CAM only. Manual key policy actions 475 are used for protecting traffic using IPsec and are installed in the SPD, CAM, and SADB on the PEP 20. Manual key policy actions 475 include a peer gateway component 477, a transform data component 480, and a set of tunnel copy flags 490.

The transform data component 480 includes a unique Security Parameters Index (SPI) value 486 generated by the originating KAP 14. The transform data component 480 also includes a cipher key 482 and a hash key 484 that specify, as an ASCII representation, the key values used for protecting traffic. The cipher key 482 specifies the cipher algorithm to be used (“aes”,“3des”, or “des”) and hash key 484 specifies the hash key algorithm to be used (“shal” or “md5”).

The set of tunnel copy flags 490 are used for special handling of IP addresses and MAC addresses on the outer ESP header of an IPsec packet. The flags 490 are only processed for “outbound” policies on the PEP 20. There are four flags that may be set independently: “copy source IP address” 492, “copy destination IP address”, “copy source MAC address” 496, and “copy destination MAC address” 498.

The transaction 300 is communicated by the KAP 14 and received by the PEP 20 in an ASCII XML structure and received on a port protected by TLS. The transaction details component 340 of transactions other than a “replace” transaction 341 contains a subset of the information presented above.

A “rekey” transaction 342 is used for two purposes: policy refresh or policy rekey. A policy refresh specifies one or more existing policy rules 400 to be updated with new date and time information 410. A policy rekey specifies one or more policy rules 400 with manual key policy actions 475 to be updated with a new SPI value 486 and key information 482, 484. The “rekey” transaction specifies only the information that is needed to identify the particular policy rule 400 to be updated and the new information that is to be stored in the policy rule 400.

A “status” transaction 346 provides a way for the KAP 14 to query the status of the policy rules on the PEP 20. The “status” transaction specifies a transaction sequence number 336 of a previously communicated “replace” transaction 341 for which the KAP 14 is requesting status. The PEP 20 responds with its most current transaction sequence number 336 corresponding to the last successfully processed “replace” transaction 341 that it received from the KAP 14.

While this invention has been particularly shown and described with references to example embodiments thereof, it will be understood by those skilled in the art that various changes in form and details may be made therein without departing from the scope of the invention encompassed by the appended claims.

What is claimed is:

1. A method for communicating policy information between at least one key authority point and at least one policy enforcement point, the method comprising:
generating detailed policy information from high level policy definitions at the at least one key authority point;
communicating the detailed policy information from the at least one key authority point to the at least one policy enforcement point over a network, wherein the detailed policy information conforms to an application programming interface; and
receiving and storing of the detailed policy information at the at least one policy enforcement point.

2. The method of claim 1, wherein communicating policy information includes communicating a policy name, server information, transaction information, and transaction details.

3. The method of claim 2, wherein communicating server information includes indicating one of the at least one key authority points.

4. The method of claim 2, wherein communicating transaction information includes specifying a deferred reload time.

5. The method of claim 2, wherein communicating transaction information includes specifying a transaction type.

6. The method of claim 5, wherein specifying the transaction type includes specifying a transaction type that corresponds with the transaction details.

7. The method of claim 5, wherein specifying the transaction type includes specifying a replace transaction.

8. The method of claim 2, wherein communicating transaction details includes communicating details for a replace transaction.

9. The method of claim 8, wherein communicating transaction details includes specifying a set of policy rules.

10. The method of claim 9, wherein specifying the set of policy rules includes specifying at least one policy rule.

11. The method of claim 10, wherein specifying the at least one policy rule includes specifying a policy action.

12. The method of claim 1, wherein communicating the detailed policy information includes communicating at least one key.

13. The method of claim 1, wherein communicating the detailed policy information includes communicating using transport layer security.

14. The method of claim 1, wherein communicating the detailed policy information includes communicating using remote procedure calls encoded with an extensible markup language.

15. A system for communicating security policy information between a key authority point and a policy enforcement point, the system comprising:
at least one key authority point residing on a network;
at least one policy enforcement point residing on the network; and
an application programming interface between the at least one key authority point and the at least one policy enforcement point for invoking remote procedure calls over the network.

16. The system of claim 15, wherein the application programming interface comprises: a policy name component; a server information component; a transaction information component; and a transaction details component.

17. The system of claim 16, wherein the server information component indicates one of the at least one key authority points.

18. The system of claim 16, wherein the transaction information component includes a deferred reload time.

19. The system of claim 16, wherein the transaction information component includes a transaction type.

20. The system of claim 19, wherein the transaction type indicates a type of content stored in the transaction details component.

21. The system of claim 19, wherein the transaction type indicates a replace transaction.

22. The system of claim 16, wherein the transaction details component includes details for a replace transaction.

23. The system of claim 22, wherein the transaction details component includes a set of policy rules.

24. The system of claim 23, wherein the set of policy rules includes at least one policy rule.

25. The system of claim 24, wherein the at least one policy rule includes a action component.
